(19) United States
(12) Patent Application Publication
(10) Pub. No.: US 2026/0054301 A1
(43) Pub. Date: Feb. 26, 2026

(54) ROLLING EQUIPMENT MACHINE DETERIORATION DIAGNOSING DEVICE

(71) Applicant: TMEIC Corporation, Tokyo (JP)

(72) Inventor: Ryo SAITO, Tokyo (JP)

(73) Assignee: TMEIC Corporation, Tokyo (JP)

(21) Appl. No.: 19/101,908

(22) PCT Filed: Jul. 18, 2023
(86) PCT No.: PCT/JP2023/026296

§ 371 Date: Feb. 7, 2025

(51) Int. Cl. B21B 38/00; G05B 23/02

(52) U.S. Cl. CPC B21B 38/00; G05B 23/0254; B21B 2203/00

(57) ABSTRACT

A deterioration diagnosing device of a rolling equipment machine includes an input/output data obtaining unit, a model identifying unit, a monitoring parameter calculating unit, a monitoring parameter usage determining unit, a representative value calculating unit, a representative value storage unit, and a deterioration diagnosing unit. The monitoring parameter usage determining unit includes a categorized monitoring parameter acquiring function for acquiring the monitoring parameters, so as to be classified according to categories designated depending on a rolling condition. The representative value calculating unit calculates a representative value of monitoring parameters from a predetermined time period corresponding to each of the categories. The representative value storage unit accumulates, with respect to each of the categories, the representative values over a learning period designated from a start of a monitoring process. The deterioration diagnosing unit includes a categorized deterioration determining function that determines presence/absence of deterioration with respect to each of the categories.

### TECHNICAL FIELD

The present disclosure is related to a rolling equipment machine deterioration diagnosing device for diagnosing deterioration of equipment machines installed in a rolling line.

### BACKGROUND ART

In a rolling line in which a plurality of types of equipment machines are provided, it is required to detect deterioration (response deterioration) of the equipment machines at an early stage and to prompt an operator to service/perform maintenance on the equipment machines, so as to stabilize and enhance quality of operations. For this reason, it has hitherto been studied how to acquire/accumulate operation data of such equipment machines so as to utilize the data for an early detection of deterioration that may occur in the equipment machines.

For example, PTL 1 listed below discloses a state abnormality judging device that assists maintenance of a robot (an equipment machine) by monitoring states of the robot. According to this technique, monitoring parameters obtained by directly comparing past time-series data at normal times (data in which values of an electric current flowing in a servo motor are arranged in a time series) with present-time time-series data are tallied for each day to obtain representative values. By comparing the obtained representative values with a distribution of the monitoring parameters over a designated learning period, deterioration of an actuator structuring the servo motor is determined.

### CITATION LIST

### Patent Literature

[PTL 1] International Publication No. WO 2022/024946

### SUMMARY OF THE INVENTION

### Problems to be Solved by the Invention

However, in rolling processes, equipment machines and materials being rolled interfere with each other, and the equipment machines are affected by the materials being rolled. For example, when one of the equipment machines is a pressing device (a hydraulic cylinder), the pressing device is affected by a reaction force exerted against a pressing force from a material being rolled. During a rolling process, a monitoring parameter fluctuates due to changes in rolling conditions (a steel grade, a sheet thickness, a sheet width, a goal temperature, etc.) and, even when the rolling conditions are constant, changes in a rolling status (a sheet speed, a roll force, etc. on a material being rolled which are set according to a temperature distribution). For this reason, by simply comparing two sets of time-series data directly as described in PTL 1, it is difficult to determine the presence/absence of deterioration of the equipment machines with excellent precision.

A purpose of the present disclosure is to solve the abovementioned problem. It is an object of the present disclosure to provide a rolling equipment machine deterioration diagnosing device capable of determining the presence/absence of deterioration of the equipment machines with excellent precision, even when there is mutual interference between the equipment machines and the materials being rolled that may be varied by the rolling conditions or the like.

### Solution to Problem

A first aspect of the present disclosure relates to a deterioration diagnosing device of a rolling equipment machine for determining presence/absence of deterioration of an equipment machine provided in a rolling line. The deterioration diagnosing device comprises an input/output data obtaining unit, a model identifying unit, a monitoring parameter calculating unit, a monitoring parameter usage determining unit, a representative value calculating unit, a storage unit, and a deterioration diagnosing unit. The input/output data obtaining unit, every time a material being rolled is rolled once in the rolling line, obtains input/output data that is input/output to/from the equipment machine during the rolling. The model identifying unit identifies a mathematical model from the input/output data obtained by the input/output data obtaining unit and obtains a parameter of the mathematical model. The monitoring parameter calculating unit calculates monitoring parameters from the parameter obtained by the model identifying unit. The monitoring parameter usage determining unit includes a categorized monitoring parameter acquiring function for acquiring the monitoring parameters calculated by the monitoring parameter calculating unit, so as to be classified according to categories designated depending on a rolling condition of the material being rolled. The representative value calculating unit calculates a representative value of a set of the monitoring parameters from a predetermined time period corresponding to each of the categories obtained by the monitoring parameter usage determining unit. The storage unit accumulates, with respect to each of the categories, the representative values obtained by the representative value calculating unit over a learning period designated from a start of a monitoring process. The deterioration diagnosing unit includes a normal value distribution parameter calculating function for obtaining a distribution parameter indicating a distribution of normal values, from a set of the representative values corresponding to each of the categories and having been accumulated in the storage unit, and includes a categorized deterioration determining function for determining presence/absence of deterioration with respect to each of the categories, by verifying the representative value obtained by the representative value calculating unit after the learning period, against the distribution parameter obtained by the normal value distribution parameter calculating function.

A second aspect further includes the following characteristics in addition to the first aspect. The deterioration diagnosing unit includes a comprehensive deterioration determining function that determines the presence/absence of the deterioration of the equipment machine based on a determination result corresponding to each of the categories obtained by the categorized deterioration determining function.

A third aspect further includes the following characteristics in addition to the second aspect. With respect to each of the predetermined time periods, the comprehensive deterioration determining function calculates a ratio of a number of categories determined to have deterioration to a number of categories for which the presence/absence of the deterioration was determined by the categorized deterioration determining function, and when the ratio exceeds a threshold value, the comprehensive deterioration determining function determines that the equipment machine is deteriorated.

A fourth aspect further includes the following characteristics in addition to the first aspect. The model identifying unit uses a first- or second-order ARX model as the mathematical model and provides a coefficient of the ARX model as the parameter of the mathematical model. The monitoring parameter calculating unit uses time constants or attenuation coefficients as the monitoring parameters.

A fifth aspect further includes the following characteristics in addition to the first aspect. The deterioration diagnosing device further comprises a data usage determining unit that, when a standard deviation of input data obtained by the input/output data obtaining unit is smaller than a threshold value, determines that the input/output data of the corresponding material being rolled is unusable.

A sixth aspect further includes the following characteristics in addition to the first aspect. The deterioration diagnosing device further comprises a data usage determining unit that, when a deviation between an average value of input data and an average value of output data obtained by the input/output data obtaining unit exceeds a threshold value, determines that the input/output data of the corresponding material being rolled is unusable.

A seventh aspect further includes the following characteristics in addition to the first aspect. The monitoring parameter usage determining unit further includes an outlier excluding function that, with respect to a set of monitoring parameters from a predetermined time period corresponding to each of the categories obtained by the categorized monitoring parameter acquiring function, calculates upper and lower limit values from percentiles in the set of the monitoring parameters from the predetermined time period corresponding to the category and further excludes one or more of the monitoring parameters outside a range defined by the upper and lower limit values as outliers.

An eighth aspect further includes the following characteristics in addition to the seventh aspect. The representative value calculating unit provides, as the representative value, either a median or an average value of a set of parameters of the mathematical model from a predetermined time period corresponding to each of the categories after the one or more outliers have been excluded.

A ninth aspect further includes the following characteristics in addition to the first aspect. The representative value calculating unit includes a deterioration malfunction date estimating function for accumulating the calculated representative values and plotting the accumulated values for each day, and calculating a date on which a threshold value is exceeded based on an intersection point between a line of linear approximation or polynomial approximation and the threshold value being set.

A tenth aspect further includes the following characteristics in addition to the first aspect. The categories are designated depending on at least one rolling condition selected from among: a steel grade of the material being rolled, a goal sheet thickness, a goal sheet width, a goal coiling temperature, whether or not a coil box is used, and a heating furnace type.

An eleventh aspect further includes the following characteristics in addition to the first aspect. The normal value distribution parameter calculating function calculates an average value and a standard deviation, as the distribution parameter.

A twelfth aspect further includes the following characteristics in addition to the first aspect. The categorized deterioration determining function uses one of a Hotelling's T² method and a Shewhart control chart, or both.

### Advantageous Effects of the Invention

According to the present disclosure, by managing the monitoring parameters obtained from the predetermined time period so as to be classified according to the categories designated depending on the rolling condition and determining, with respect to each of the categories, the presence/absence of deterioration of the equipment machine, it is possible to provide the rolling equipment machine deterioration diagnosing device capable of determining the presence/absence of deterioration of the equipment machine with excellent precision, even when there is mutual interference between the equipment machine and the material being rolled that may be varied by the rolling condition.

### BRIEF DESCRIPTION OF DRAWINGS

FIG. 1 is a schematic drawing showing a configuration of a rolling line to which a deterioration diagnosing device of a rolling equipment machine according to an embodiment is applied.

FIG. 2 is a schematic drawing showing a configuration of the deterioration diagnosing device of a rolling equipment machines.

FIG. 3 is a schematic diagram showing total length data serving as input/output data obtained by the input/output data obtaining unit shown in FIG. 2.

FIG. 4 is a schematic diagram showing functions included in a monitoring parameter usage determining unit shown in FIG. 2.

FIG. 5 is a schematic diagram showing functions included in a deterioration diagnosing unit shown in FIG. 2.

FIG. 6 is a conceptual diagram showing a hardware configuration example of a processing circuit included in the deterioration diagnosing device of a rolling equipment machines.

### DESCRIPTION OF EMBODIMENTS

The following will describe embodiments of the present disclosure with reference to the drawings. Some of the elements that are the same as or correspond to each other in the drawings are referred to by using the same reference characters, and the descriptions thereof will be simplified or omitted.

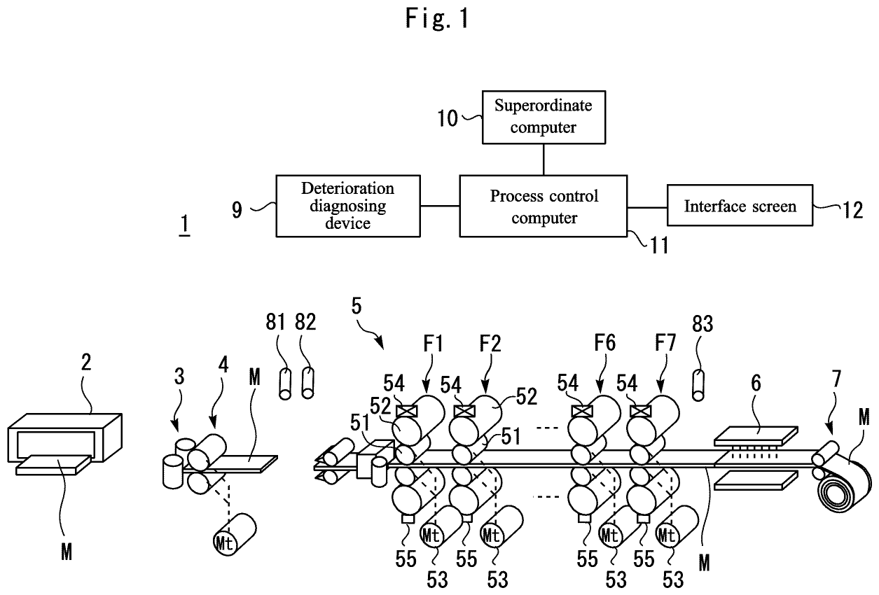

FIG. 1 is a schematic drawing showing a configuration of a rolling line to which a deterioration diagnosing device of a rolling equipment machine according to an embodiment is applied. A rolling line 1 shown in FIG. 1 is for rolling a material to be rolled M into a sheet form with heat, while steel or metal of other types is used as the material to be rolled M. Installed in the rolling line 1 as primary equipment are a heating furnace 2, an edger 3, a roughing mill 4, a crop shear (not shown), a coil box (not shown), a finishing mill 5, a cooling device 6, and a coiler 7.

The heating furnace 2 is configured to heat a slab, which is the material to be rolled M before being rolled, up to a prescribed temperature. The edger 3 is configured to shape the material to be rolled M so as to have a prescribed sheet width.

The roughing mill 4 has at least one (usually one to three) rolling stand (which hereinafter may be called “stand”) and is configured to perform, on the material being rolled M heated by the heating furnace 2, a rolling process in multiple passes in a forward direction (the direction from the upstream side to the downstream side of the rolling line) and a backward direction (the direction from the downstream side to the upstream side of the rolling line). While disposed on the downstream side of the roughing mill 4, the crop shear (not shown) is configured, based on a shape measured by a shape detector 81 (described later), to cut off a shape defect part that is present in a head end part or a tail end part of the material being rolled M, by using top and bottom blades. In addition, the coil box (not shown) may be disposed between the roughing mill 4 and the finishing mill 5, so that the material being rolled M that has roughly been rolled is temporarily wound into a coil shape. However, the coil box may be omitted from the rolling line 1.

For example, the finishing mill 5 may be a hot tandem rolling mill. The finishing mill 5 includes a plurality of (seven in the present embodiment) stands F1 to F7 that are arranged side by side along a transport direction of the material being rolled M. Each of the stands F1 to F7 includes two (top and bottom) work rolls 51, two (top and bottom) backup rolls 52, and a motor 53 for roll rotation. For example, the backup rolls 52 are provided with a pressing device 54 such as a hydraulic cylinder. The pressing device 54 is configured to be able to adjust a roll gap between the top and bottom work rolls 51. The roll forces of the stands F1 to F7 are measured by a roll force sensor 55. For example, the roll force sensor 55 may be a load cell. Further, the roll gap of each of the rolling stands F1 to F7 is measured by a gap sensor (not shown) such as a Magnescale. Further, a looper (not shown) is disposed between any two stands positioned adjacent to each other, so as to control tension of the material being rolled M between the stands.

The cooling device 6 is configured to be able to cool the material being rolled M, by pouring water over the material being rolled M while using a cooling bank. The material being rolled M that has been cooled is wound into a coil shape by the coiler 7.

At relevant locations in the rolling line 1, various types of sensors serving as various types of measurement tools are installed. The relevant locations in the rolling line 1 may be, for example, the delivery side of the heating furnace 2, the delivery side of the roughing mill 3, the delivery side of the finishing mill 5, the entry side of the coiler 7, and/or the like. The various types of sensors may also be provided between the stands F1 to F7 of the finishing mill 5. The various types of sensors include: the shape detector 81 capable of measuring the shape (including the sheet width) of the material being rolled M on the delivery side of the roughing mill 3; a pyrometer 82 that measures a surface temperature of the material being rolled M on the upstream side of the finishing mill 5; a thickness meter 83 that measures the actual thickness of the material being rolled M on the delivery side of the finishing mill 5; the roll force sensor 55 that measures the roll forces of the stands F1 to F7; and the gap sensor that measures the roll gaps of the stands F1 to F7. The various types of sensors successively measure states of the material being rolled M and the equipment machines.

The rolling line 1 is operated (run) by a control system using a computer. The computer includes a superordinate computer 10 and a process control computer 11 that are connected to each other via a network. To the process control computer 11, an interface screen 12 serving as a screen to be operated by an operator is connected via a network. The operator is able to perform an operation to input a control condition and the like, on the interface screen 12. The interface screen 12 may also serve as a screen display device DP (described later).

The process control computer 11 executes setting calculation/control over elements being controlled, during a series of rolling processes. In addition, the process control computer 11 further has a function of correcting the roll gaps of the stands F1 to F7. To the process control computer 11, product information is input by the superordinate computer 10. The product information includes: goal information (product goals) such as a goal sheet thickness (a product thickness), a goal sheet width, and the like, as well as a steel grade of the material being rolled M that has been heated by the heating furnace 2.

The process control computer 11 controls each piece of equipment appropriately, based on the goal information, the control condition provided on the interface screen 12, and the like. For example, the process control computer 11 may be a controller. When the material being rolled M has been transported to a prescribed position in the rolling line 1, the process control computer 11 calculates a setting of each piece of equipment capable of achieving the goal information and operates an actuator or a motor (a rotor) of each piece of equipment such as the hydraulic cylinder structuring the pressing device 54 in each of the stands F1 to F7, for example, based on the setting values.

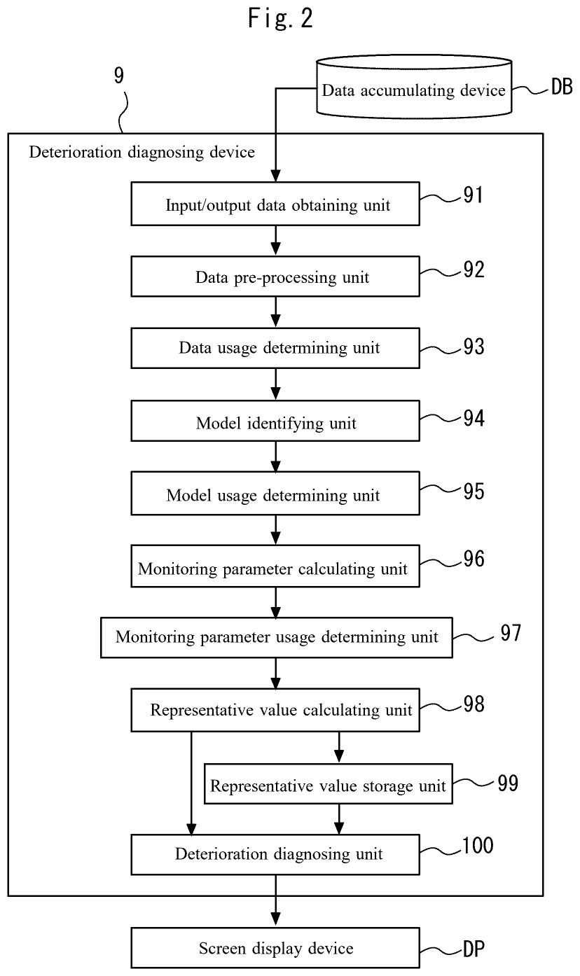

FIG. 2 is a schematic drawing showing a configuration of a deterioration diagnosing device 9 for diagnosing (determining) deterioration of the equipment machines (which hereinafter may be referred to as “rolling equipment machines”) installed in the rolling line 1. The rolling equipment machines targeted by the deterioration diagnosing device 9 include hydraulic cylinders used in the edger 3, the roughing mill 4, and the finishing mill 5, as well as motors (rotors) used in the edger 3, the roughing mill 4, the finishing mill 5, and the looper. In the present embodiment, an example will be described in which, among these rolling equipment machines, the hydraulic cylinder serving as the pressing device 54 of the finishing mill 5 is to be targeted.

The deterioration diagnosing device 9 includes an input/output data obtaining unit 91, a data pre-processing unit 92, a data usage determining unit 93, a model identifying unit 94, a model usage determining unit 95, a monitoring parameter calculating unit 96, a monitoring parameter usage determining unit 97, a representative value calculating unit 98, a representative value storage unit 99, and a deterioration diagnosing unit 100.

To the deterioration diagnosing device 9, a data accumulating device DB and the screen display device DP are connected. The data accumulating device DB acquires and accumulates therein a large number of items of data from machines that are used in the rolling process such as the various types of sensors and the process control computer (controller) 11 described above, and the like. For example, the data accumulating device DB may be a database. The screen display device DP is for displaying a deterioration diagnosis result (a deterioration determination result) which is an output of the deterioration diagnosing device 9. Alternatively, the data accumulating device DB and the screen display device DP may be provided inside the deterioration diagnosing device 9.

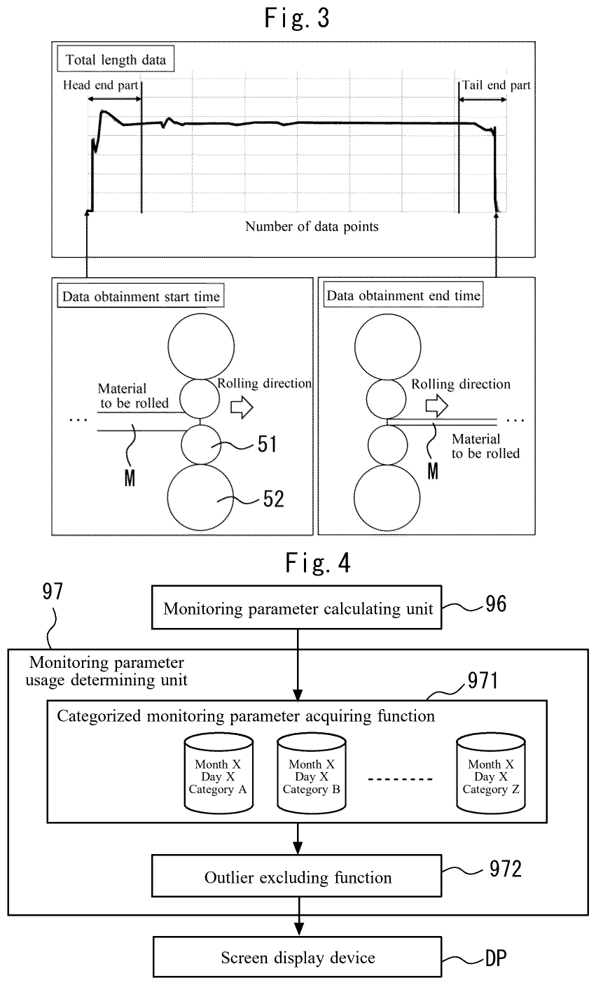

The input/output data obtaining unit 91 is for extracting and obtaining input data and output data (hereinafter, “input/output data”) to and from the targeted equipment machines, from among the large number of items of data accumulated in the data accumulating device DB. In the present embodiment, the input/output data is a pair made up of a command value (input data) and an actual value (output data) related to the position of the pressing device (hydraulic cylinder) 54 during the rolling process of the material being rolled M. As shown in FIG. 3, the input/output data obtaining unit 91 extracts the input/output data of the pressing device 54 from a data obtainment start time (the time at which the material being rolled M is engaged with the stand) to a data obtainment end time (the time at which the material being rolled M is released from the stand). The input/output data extracted by the input/output data obtaining unit 91 in this manner may be called “total length data”.

The data pre-processing unit 92 performs pre-processing on the total length data of the equipment machines extracted by the input/output data obtaining unit 91. More specifically, from the total length data shown in FIG. 3, the data in a head end part and a tail end part being unstable in a transient state are excluded. With this arrangement, it is possible to avoid using the data in the head end part and the tail end part for the deterioration diagnosis. When the input data after excluding the data in the head end part and the tail end part is expressed as x, and the output data after the exclusion is expressed as y, it is possible to define the input data x and the output data y by using Expressions (1) and (2) presented below.

$$[ Math 1 ]$$

$$x = [ x ( 0 ) x ( 1 ) x ( 2 ) … x ( n ) ] \qquad ( 1 )$$

$$[ Math 2 ]$$

$$y = [ y ( 0 ) y ( 1 ) y ( 2 ) … y ( n ) ] \qquad ( 2 )$$

where n denotes the number of data points shown in FIG. 3.

The data usage determining unit 93 determines whether or not the input/output data pre-processed by the data pre-processing unit 92 is input data suitable for the deterioration determining process. For example, when the input data x pre-processed by the data pre-processing unit 92 has small fluctuations or when there is an offset between the input data x and the output data y, the data usage determining unit 93 determines that the input/output data of the material being rolled M is not suitable for the deterioration determining process and excludes the input/output data of the material being rolled M from the data subject to the diagnosing process.

More specifically, at first, when the input data x has small fluctuations, i.e., when a standard deviation ox of the input data x is smaller than a threshold value fox being a prescribed reference value, it is determined that the input/output data of the material being rolled M is unusable, and the input/output data of the material being rolled M is excluded from the data subject to the diagnosing process. When the input/output data has small fluctuations, because the data usage determining unit 93 is unable to properly obtain dynamic characteristics of the equipment machines, there is a possibility that the monitoring parameters (described later) serving as an index for a degree of deterioration might lose significance thereof.

$$[ Math 3 ]$$

$${σ}_{x} < {θ}_{σ\_ x} \qquad ( 3 )$$

Next, when there is an offset between the input data x and the output data y, if the deviation between an average value xₐᵥₑ of the input data x and an average value yₐᵥₑ of the output data y is equal to or larger than a threshold value θ_{OFS} being a prescribed reference value, the data usage determining unit 93 determines that the input/output data of the material being rolled M is unusable and excludes the input/output data of the material being rolled M from the data subject to the diagnosing process.

$$[ Math 4 ]$$

$$\vert {x}_{ave} - {y}_{ave} \vert < {θ}_{OFS} \qquad ( 4 )$$

The model identifying unit 94 identifies an ARX model from the input/output data of the material being rolled M that was not excluded by the data usage determining unit 93. Possible levels of the order of the ARX model include the first order and the second order. It is possible to select the level of the order for each of the equipment machines subject to the diagnosing process. It is desirable to determine the level of the order of the ARX model suitable for each targeted equipment machine in advance, through experiments or simulations.

The first-order ARX model can be expressed by using Expression (5) presented below.

$$[ Math 5 ]$$

$$y ( m ) = {a}_{1 \_ 1} y ( m - 1 ) + {b}_{{1}_{1}} x ( m - 1 ) \qquad ( 5 )$$

where a₁₁ denotes a model coefficient of the output data; b₁₁ denotes a model coefficient of the input data; and m denotes an arbitrary data point.

The model coefficients a₁₁ and b₁₁ to be identified are determined by using Expression (6) presented below, so as to minimize the sum of squared errors between the output data y and the calculated values from the ARX model.

$$[ Math 6 ]$$

$${arg min}_{[ {a}_{1 \_ 1} , {b}_{1 \_ 1} ]} {\sum }_{m = 2}^{n} {( y ( m ) - ( {a}_{1 \_ 1} y ( m - 1 ) + {b}_{1 \_ 1} x ( m - 1 ) ) )}^{2} \qquad ( 6 )$$

Further, the second-order ARX model can be expressed by using Expression (7) presented below.

$$[ Math 7 ]$$

$$y ( m ) = {a}_{1 \_ 2} y ( m - 1 ) + {a}_{2 \_ 2} y ( m - 2 ) + {b}_{1 \_ 2} x ( m - 1 ) \qquad ( 7 )$$

where a₁₁ and a₂₂ denote model coefficients of the output data y; b₁₂ denotes a model coefficient of the input data x; and m denotes an arbitrary data point.

The model coefficients a₁₁, a₂₂, and b₁₂ to be identified are determined so as to minimize the sum of squared errors between the output data and the calculated values from the ARX model.

$$[ Math 8 ]$$

$${arg min}_{[ {a}_{1 \_ 2} , {a}_{2 \_ 2} , {b}_{1 \_ 2} ]} {\sum }_{m = 2}^{n} {( y ( m ) - ( {a}_{1 \_ 2} y ( m - 1 ) + {a}_{2 \_ 2} y ( m - 2 ) + {b}_{1 \_ 2} x ( m - 1 ) ) )}^{2} \qquad ( 8 )$$

Based on the signs of the coefficients of the ARX model obtained by the model identifying unit 94, the model usage determining unit 95 determines whether or not the result is usable for a response deterioration diagnosing process. More specifically, when Expression (9) is satisfied for the first-order ARX model and when Expression (10) is satisfied for the second-order ARX model, because it is not possible to calculate the monitoring parameters by using Expression (11) or (12) described below, the result of identifying the model for the material being rolled M is excluded from the results subject to the diagnosing process.

$$[ Math 9 ]$$

$${a}_{1 \_ 1} < 0 \qquad ( 9 )$$

$$[ Math 10 ]$$

$${a}_{2 \_ 2} > 0 \qquad ( 10 )$$

The monitoring parameter calculating unit 96 calculates the monitoring parameter by using certain model coefficients of the material being rolled M that were not excluded by the model usage determining unit 95. As the monitoring parameter, the first-order ARX model adopts a time constant t, whereas the second-order ARX model adopts an attenuation coefficient ζ.

For the first-order ARX model, the time constant t is calculated by using the model coefficient a₁₁, according to Expression (11) presented below.

$$[ Math 11 ]$$

$$τ = - \frac{{T}_{s}}{log {a}_{11}} \qquad ( 11 )$$

where Tₛ denotes a sampling pitch.

For the second-order ARX model, the attenuation coefficient ζ is calculated by using the model coefficients a₁₁ and a₂₂. To begin with, the product of the attenuation coefficient ζ and a natural angular frequency ωₙ is calculated by using a₂₂ according to Expression (12) presented below.

$$[ Math 12 ]$$

$${ζω}_{n} = \frac{- log ( - {a}_{2 \_ 2} )}{2 {T}_{s}} \qquad ( 12 )$$

where Tₛ denotes a sampling pitch.

Subsequently, the natural angular frequency ωₙ is calculated by using the product ζωₙ, according to Expression (14) presented below. At that time, the calculation expression is switched between the two, by referring to Og calculated by using Expression (13) presented below.

$$[ Math 13 ]$$

$${θ}_{ζ} = \frac{{a}_{1 \_ 2} {e}^{ζ {ω}_{n} δ t}}{2} \qquad ( 13 )$$

$$[ Math 14 ]$$

$${ω}_{n} = \{ \begin{matrix}\sqrt{{ω}_{n}^{2} {ζ}^{2} + \frac{{arccos}^{2} ( \frac{{a}_{1 \_ 2} {e}^{ζ {ω}_{n} {T}_{s}}}{2} )}{{T}_{s}^{2}}} & {θ}_{ζ} \leq 1 \\ \sqrt{{ω}_{n}^{2} {ζ}^{2} - \frac{arccos {h}^{2} ( \frac{{a}_{1 \_ 2} {e}^{ζ {ω}_{n} δ t}}{2} )}{{T}_{s}^{2}}} & {θ}_{ζ} > 1\end{matrix} \qquad ( 14 )$$

Lastly, the attenuation coefficient ζ is calculated by using the natural angular frequency ωₙ according to Expression (15) presented below.

$$[ Math 15 ]$$

$$ζ = \frac{- log ( - {a}_{2 \_ 2} )}{2 {T}_{s} {ω}_{n}} \qquad ( 15 )$$

FIG. 4 is a schematic diagram showing functions included in the monitoring parameter usage determining unit 97. With reference to the flowchart in FIG. 4, operations of the monitoring parameter usage determining unit 97 will be described. The monitoring parameter usage determining unit 97 includes a categorized monitoring parameter acquiring function 971 and an outlier excluding function 972.

The categorized monitoring parameter acquiring function 971 acquires, for each day for example, the monitoring parameters obtained by the monitoring parameter calculating unit 96, so as to be classified according to categories designated depending on the rolling conditions (which may be referred to as “being classified according to the categories corresponding to layers”). In this situation, the categories are designated depending on at least one rolling condition selected from among: the steel grade, a goal sheet thickness, a goal sheet width, a goal coiling temperature, whether or not the coil box is used, and a heating furnace type. By managing the monitoring parameters so as to be classified according to the categories designated depending on the rolling conditions, it is possible to prevent the monitoring parameters from being affected by the material being rolled (the material) M.

The outlier excluding function 972 excludes one or more of monitoring parameters being outliers, from the monitoring parameters corresponding to each day acquired by the categorized monitoring parameter acquiring function 971. In a set of monitoring parameters x corresponding to one day classified according to the categories, one or more of the monitoring parameters x that do not satisfy Expression (16) presented below are determined to be the outliers. The outliers are accidental values and values affected by a manual interference of an operator of the rolling line 1. Because these outliers may bring about degradation of the precision level of the deterioration determination, the outliers are excluded by the outlier excluding function 972.

$$[ Math 16 ]$$

$${P}_{25} - α ( {R}_{75} - {P}_{25} ) < 𝓍 < {p}_{75} + α ( {P}_{75} - {P}_{25} ) \qquad ( 16 )$$

In the above expression, P₇₅ denotes the 75th percentile of the monitoring parameters corresponding to one day, whereas P₂₅ denotes the 25th percentile of the monitoring parameters corresponding to one day, and α denotes an arbitrary multiplying factor.

The representative value calculating unit 98 calculates a representative value of the set made up of the monitoring parameters from a predetermined time period in each of the categories that were not excluded by the monitoring parameter usage determining unit 97. More specifically, the representative value calculating unit 98 calculates either an average value or a median of the set made up of the monitoring parameters from the predetermined time period in each of the categories and provides the calculated average value or median as the representative value. At that time, when the monitoring parameter usage determining unit 97 has excluded the outliers, if the number of materials being rolled M per day in each of the categories is too small, the monitoring parameters may have an uneven distribution, and there is a possibility that deterioration may be diagnosed by mistake. In that situation, it is acceptable to skip the calculation of the representative value of such a day. Further, it is also acceptable to additionally provide the representative value calculating unit 98 with a deterioration malfunction date estimating function for predicting a date on which deterioration may occur, by plotting the obtained representative values for each day and calculating the date on which a threshold value is exceeded, based on an intersection point between a line of linear approximation or polynomial approximation and the threshold value being set.

The representative part storage unit 99 accumulates, with respect to each of the categories, the representative values obtained by the representative value calculating unit 98, while using a number of days designated, in advance, from a monitoring start day, as a learning period. Alternatively, the quantity of the accumulated representative values may be counted for each of the categories, so as to use, as the learning period, a time period until representative values corresponding to a designated number of days have been accumulated.

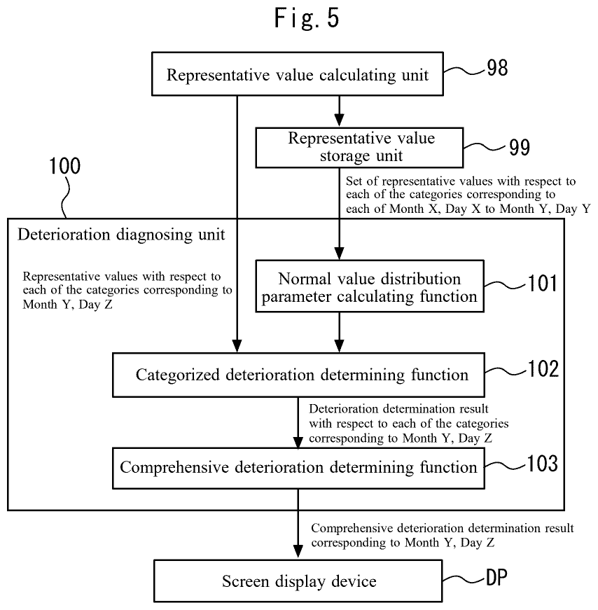

FIG. 5 is a schematic diagram showing functions included in the deterioration diagnosing unit 100. With reference to the flowchart in FIG. 5, operations of the deterioration diagnosing unit 100 will be described.

The deterioration diagnosing unit 100 includes a normal value distribution parameter calculating function 101, a categorized deterioration determining function 102, and a comprehensive deterioration determining function 103.

The normal value distribution parameter calculating function 101 obtains a set of representative values with respect to each of the categories corresponding to each of the days during the learning period (e.g., Month X, Day X to Month Y, Day Y) that have been accumulated in the representative part storage unit 99. Based on the set of representative values with respect to each of the categories corresponding to each of the days during the learning period and having been obtained from the representative part storage unit 99, the normal value distribution parameter calculating function 101 calculates, for example, an average value and a standard deviation of the representative values each corresponding to a different one of the days during the learning period, as distribution parameters indicating a distribution of normal values.

The categorized deterioration determining function 102 determines the presence/absence of deterioration with respect to each of the categories, by verifying (comparing) the representative value obtained by the representative value calculating unit 98 after the learning period against (with) the distribution parameters obtained by the normal value distribution parameter calculating function 101. Although there are many methods for this type of determination, the categorized deterioration determining function 102 is able to make the determination by using, for example, one of the Hotelling's T² method and a Shewhart control chart, or both.

At first, the Hotelling's T² method will be described. On the assumption that the monitoring parameters serving as a population conform to a normal distribution, an abnormality degree H of a j-th day (e.g., the Z-th day of the Y-th month) is calculated, by using a representative value of the j-th day expressed as xᵣₑₚ(j), an average value “x_{rep,ave}” and a standard deviation “θ_{x_rep}” of the representative values each corresponding to a different one of the days during the learning period.

$$[ Math 17 ]$$

$$H ( j ) = \frac{{( {𝓍}_{rep} ( j ) - {𝓍}_{rep , ave} )}^{2}}{{σ}_{𝓍\_ ave}^{2}} \qquad ( 17 )$$

An arbitrary threshold value is provided for the abnormality degree H, so as to determine that deterioration is present when the threshold value is exceeded. It is theoretically proved that the abnormality degree H conforms to a chi-squared distribution having 1 degree of freedom. It is possible to calculate the probability of H being a certain value. For example, the probability of H=3.84 being true is approximately 5%. The probability of H=6.63 being true is approximately 1%. The probability of H=10.8 being true is approximately 0.1%. By referencing the relationship between the abnormality value H and the probabilities, it is possible to set the threshold value used for determining the deterioration.

Next, a determination method using a Shewhart control chart will be described. While using, as threshold values, constant multiples of the standard deviation Ox rep in the positive and the negative directions from a reference value being the average value “x_{rep,ave}” of the representative values each corresponding to a different one of the days during the learning period, if the representative value xᵣₑₚ(j) of the j-th day (e.g., the Z-th day of the Y-th month) is outside the threshold value range, it is determined that deterioration is present.

Other determination methods that can be used by the categorized deterioration determining function 102 include, for example, a method by which, while using a constant multiple of the average value of the representative values each corresponding to a different one of the days during the learning period as a threshold value, if the representative value exceeds the threshold value, it is determined that deterioration is present. Alternatively, it is also acceptable to prepare a plurality of threshold values for one determination method, so as to determine degrees of deterioration at stages.

The comprehensive deterioration determining function 103 comprehensively determines (makes a final determination about) the presence/absence of deterioration of the equipment machines, based on a deterioration diagnosis result (a determination result) corresponding to each of the categories obtained by the categorized deterioration determining function 102. More specifically, with respect to each day, among the categories for which the categorized deterioration determining function 102 determined the presence/absence of deterioration for that date, the ratio of the number of categories determined to have deterioration is calculated, and if the ratio exceeds a threshold value, the machine is determined to be deteriorated. By providing the comprehensive deterioration determining function 103 in this manner, it is possible to determine the deterioration with excellent precision, even when there are a large number of categories.

Further, the comprehensive determination may be made by applying equal weights to the determination results corresponding to the different categories that were obtained by the categorized deterioration determining function 102. Alternatively, the comprehensive determination may be made by applying mutually-different weights to the determination results corresponding to the different categories. For example, it is also acceptable to make the comprehensive determination by applying a larger weight to a determination result about the category of a steel grade being rolled in a large quantity or a determination result about a steel grade that requires a stricter judgment. With these arrangements, it is possible to determine the deterioration with an even higher level of precision.

As described above, the present embodiment adopts the configuration in which the monitoring parameters obtained by the monitoring parameter calculating unit 96 are managed by the monitoring parameter usage determining unit 97 while being classified according to the categories designated depending on the rolling conditions with respect to each of the predetermined time periods, so that the deterioration diagnosing unit 100 determines, with respect to each of the categories, the presence/absence of deterioration of the equipment machines. With this configuration, it is possible to provide the deterioration diagnosing device 9 capable of determining the presence/absence of deterioration of the equipment machines with excellent precision, even when there is mutual interference between the equipment machines and the material being rolled M that may be varied by the rolling conditions or the like. Further, because the comprehensive deterioration determining function 103 makes the comprehensive determination by using the determination result of each of the categories, it is possible to make the determination with excellent precision even when there are a large number of categories. Furthermore, because the data usage determining unit 93 sorts out the input/output data suitable for the deterioration determination process, and the outlier excluding function 972 excludes the outliers from the set of monitoring parameters in each of the categories, it is possible to make the determination with an even higher level of precision.

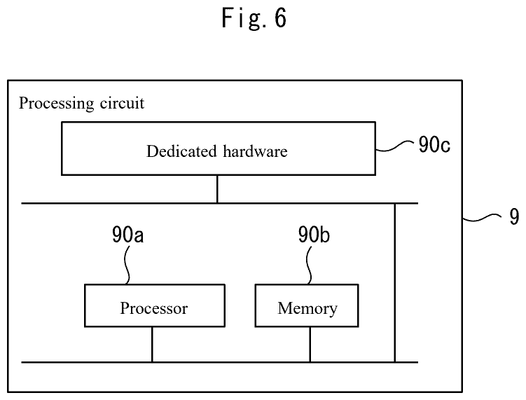

Next, a specific structure of the abovementioned deterioration diagnosing device 9 will be described. Although there is no limitation thereto, the specific structure of the deterioration diagnosing device 9 may be configured as described below in an example. FIG. 6 is a conceptual diagram showing a hardware configuration example of a processing circuit included in the deterioration diagnosing device 9. The units and the functions structuring the deterioration diagnosing device 9 are realized by the processing circuit. For example, the processing circuit includes at least one processor 90a and at least one memory 90b. For example, the processing circuit includes at least one piece of dedicated hardware 90c. As a specific example, the processing circuit may be a Personal Computer (PC) or the like.

When the processing circuit includes the processor 90a and the memory 90b, the functions included in the deterioration diagnosing device 9 are realized by software, firmware, or a combination of software and firmware. At least one of the software and the firmware is written as a program. At least one of the software and the firmware is stored in a memory 402. The processor 90a realizes the functions by reading and executing the program stored in the memory 90b. A processor 401 may be referred to as a Central Processing Unit (CPU), a central processing device, a processing device, a computing device, a microprocessor, a microcomputer, or a DSP. For example, the memory 402 may be a non-volatile or volatile semiconductor memory such as a RAM, a ROM, a flash memory, an EPROM, or an EEPROM, or a magnetic disk, a flexible disk, an optical disk, a compact disk, a mini disk, a DVD, or the like.

When the processing circuit includes the dedicated hardware 90c, the processing circuit is, for example, a single circuit, a composite circuit, a programmed processor, a parallel-programed processor, an ASIC, an FPGA, or a combination of any of these. In an example, each of the functions may be realized by a processing circuit. In another example, the functions may collectively be realized by a processing circuit. Further, one or more of the functions may be realized by the dedicated hardware 90c, while the other functions are realized by software or firmware. As described herein, the processing circuit realizes the functions by using the hardware 90c, the software, the firmware, or a combination of any of these.

Certain embodiments of the present disclosure have thus been described; however, the present disclosure is not limited to the embodiments described above and may be carried out while being modified in various manners without departing from the gist of the present disclosure. For example, although the example was described in the above embodiments in which the targeted controlled machine is the hydraulic cylinder structuring the pressing device 54 of the finishing mill 5, possible embodiments are not limited to this example. It is also acceptable to apply the present disclosure to an element installed in the hot rolling line.

Further, while numerical values such as the quantities of the elements, amounts, volumes, and ranges are mentioned in the embodiments described above, the present disclosure is not limited by the stated numbers, unless the limitation is particularly noted explicitly or the numbers should evidently be so specified in principle. Further, the structures and the like described in the above embodiments are not necessarily requisite in the present invention, unless the requisition is particularly noted explicitly or the configurations should evidently be so specified in principle.

### REFERENCE SIGNS LIST

1 . . . rolling line, M . . . material to be rolled, 5 . . . finishing mill, F1 to F6 . . . rolling stand, 54 . . . pressing device, 9 . . . deterioration diagnosing device, 91 . . . input/output data obtaining unit, 92 . . . data pre-processing unit, 93 . . . data usage determining unit, 94 . . . model identifying unit, 95 . . . model usage determining unit, 96 . . . monitoring parameter calculating unit, 97 . . . monitoring parameter usage determining unit, 971 . . . categorized monitoring parameter acquiring function, 972 . . . outlier excluding function, 98 . . . representative value calculating unit, 99 . . . representative value storage unit, 100 . . . deterioration diagnosing unit, 101 . . . normal value distribution parameter calculating function, 102 . . . categorized deterioration determining function, 103 . . . comprehensive deterioration determining function

1. A deterioration diagnosing device of a rolling equipment machine for determining presence/absence of deterioration of an equipment machine provided in a rolling line, comprising:
input/output data obtaining circuitry that, every time a material being rolled is rolled once in the rolling line, obtains input/output data that is input/output to/from the equipment machine during the rolling;
model identifying circuitry that identifies a mathematical model from the input/output data obtained by the input/output data obtaining circuitry and obtains a parameter of the mathematical model;
monitoring parameter calculating circuitry that calculates monitoring parameters from the parameter obtained by the model identifying circuitry;
monitoring parameter usage determining circuitry including categorized monitoring parameter acquiring circuitry function for acquiring the monitoring parameters calculated by the monitoring parameter calculating circuitry, so as to be classified according to categories designated depending on a rolling condition of the material being rolled;
representative value calculating circuitry that calculates a representative value of a set of the monitoring parameters from a predetermined time period corresponding to each of the categories obtained by the monitoring parameter usage determining circuitry;
storage circuitry that accumulates, with respect to each of the categories, the representative values obtained by the representative value calculating circuitry over a learning period designated from a start of a monitoring process; and
deterioration diagnosing circuitry including normal value distribution parameter calculating circuitry for obtaining a distribution parameter indicating a distribution of normal values, from a set of the representative values corresponding to each of the categories and having been accumulated in the storage circuitry, and categorized deterioration determining circuitry for determining presence/absence of deterioration with respect to each of the categories, by verifying the representative value obtained by the representative value calculating circuitry after the learning period, against the distribution parameter obtained by the normal value distribution parameter calculating circuitry.

2. The deterioration diagnosing device of a rolling equipment machine according to claim 1, wherein
the deterioration diagnosing circuitry includes comprehensive deterioration determining circuitry that determines the presence/absence of the deterioration of the equipment machine based on a determination result corresponding to each of the categories obtained by the categorized deterioration determining circuitry.

3. The deterioration diagnosing device of a rolling equipment machine according to claim 2, wherein
with respect to each of the predetermined time periods, the comprehensive deterioration determining circuitry calculates a ratio of a number of categories determined to have deterioration to a number of categories for which the presence/absence of the deterioration was determined by the categorized deterioration determining circuitry, and when the ratio exceeds a threshold value, the comprehensive deterioration determining circuitry determines that the equipment machine is deteriorated.

4. The deterioration diagnosing device of a rolling equipment machine according to claim 1, wherein
the model identifying circuitry uses a first- or second-order ARX model as the mathematical model and provides a coefficient of the ARX model as the parameter of the mathematical model, and
the monitoring parameter calculating circuitry uses time constants or attenuation coefficients as the monitoring parameters.

5. The deterioration diagnosing device of a rolling equipment machine according to claim 1, further comprising:
data usage determining circuitry that, when a standard deviation of input data obtained by the input/output data obtaining circuitry is smaller than a threshold value, determines that the input/output data of the corresponding material being rolled is unusable.

6. The deterioration diagnosing device of a rolling equipment machine according to claim 1, further comprising:
data usage determining circuitry that, when a deviation between an average value of input data and an average value of output data obtained by the input/output data obtaining circuitry exceeds a threshold value, determines that the input/output data of the corresponding material being rolled is unusable.

7. The deterioration diagnosing device of a rolling equipment machine according to claim 1, wherein
the monitoring parameter usage determining circuitry further includes outlier excluding circuitry that, with respect to a set of monitoring parameters from a predetermined time period corresponding to each of the categories obtained by the categorized monitoring parameter acquiring circuitry, calculates upper and lower limit values from percentiles in the set of the monitoring parameters from the predetermined time period corresponding to the category and further excludes one or more of the monitoring parameters outside a range defined by the upper and lower limit values as outliers.

8. The deterioration diagnosing device of a rolling equipment machine according to claim 7, wherein
the representative value calculating circuitry provides, as the representative value, either a median or an average value of a set of parameters of the mathematical model from a predetermined time period corresponding to each of the categories after the one or more outliers have been excluded.

9. The deterioration diagnosing device of a rolling equipment machine according to claim 1, wherein
the representative value calculating circuitry includes deterioration malfunction date estimating circuitry for accumulating the calculated representative values and plotting the accumulated values for each day, and calculating a date on which a threshold value is exceeded based on an intersection point between a line of linear approximation or polynomial approximation and the threshold value being set.

10. The deterioration diagnosing device of a rolling equipment machine according to claim 1, wherein
the categories are designated depending on at least one rolling condition selected from among: a steel grade of the material being rolled, a goal sheet thickness, a goal sheet width, a goal coiling temperature, whether or not a coil box is used, and a heating furnace type.

11. The deterioration diagnosing device of a rolling equipment machine according to claim 1, wherein
the normal value distribution parameter calculating circuitry calculates an average value and a standard deviation, as the distribution parameter.

12. The deterioration diagnosing device of a rolling equipment machine according to claim 1, wherein
the categorized deterioration determining circuitry uses one of a Hotelling's T² method and a Shewhart control chart, or both.
